(19) United States
(12) Patent Application Publication
(10) Pub. No.: US 2003/0134735 A1
(43) Pub. Date: Jul. 17, 2003

(54) Method for producing porous inorganic solids on the basis of an aqueous composite particle dispersion

(76) Inventors: Zhijian Xue, Ludwigshafen (DE); Harm Wiese, Heidelberg (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/275,764

(22) PCT Filed: May 8, 2001
(86) PCT No.: PCT/EP01/05196

(30) Foreign Application Priority Data
May 18, 2000 (DE) 10024561.7

(51) Int. Cl. C04B 38/06

(52) U.S. Cl. 501/81; 264/44

(57) ABSTRACT

The invention relates to a method for producing porous inorganic solids on the basis of an aqueous dispersion of particles that are composed of a polymer and finely divided inorganic solids.

### DESCRIPTION

The present invention relates to a process for the preparation of porous inorganic solid bodies from an aqueous dispersion of particles composed of polymer and finely divided inorganic solid matter. The invention also relates to the use of said porous inorganic solid bodies.

The manufacture of porous inorganic solid bodies using aqueous polymer dispersions is backed by the following prior art.

DE-A 19,639,016 discloses a process for the preparation of porous silicon dioxide, in which silicon dioxide is precipitated by means of a chemical sol-gel process from silicon dioxide precursors in the presence of an aqueous polymer dispersion, and the three-dimensional network of said silicon dioxide contains built-in polymer particles. These are removed from the three-dimensional structure in a subsequent process by heating.

The preparation of porous calcium carbonate is described by D. Walsh and S. Mann in Nature, 1995, 377, pages 320 to 323. Starting from a supersaturated calcium hydrogencarbonate solution, calcium hydrogencarbonate is precipitated in the presence of an oil-in-water microemulsion. By gently heating the precipitated calcium hydrogencarbonate the latter is converted to calcium carbonate by elimination of water and carbon dioxide, whilst simultaneously the organic phase is removed from the solid body.

Another process for the preparation of porous solid bodies is described by A. Imhof and D. J. Pine in Nature, 1987, 389, pages 948 to 951. The disclosure relates to the formation of a porous three-dimensional structure by precipitation of inorganic solid matter by means of a sol-gel process, which is carried out in the presence of a monodisperse oil-in-water emulsion. After the solid has been dried and calcined there remains a porous inorganic solid body.

B. T. Holland et al. (cf Science 1998, 281, pages 538 to 540) describe the preparation of porous titanium(IV) oxide, zirconium(IV) oxide and aluminum oxide solid bodies from the corresponding metal alkoxide precursors in the presence of well-ordered polymer particles. Following application of the metal alkoxides to the surface of the solid polymer particles there is obtained a porous inorganic structure due to burning of the organic material during the heating stage.

G. Subramanian et al. disclose in Adv. Mat. 1999, 11(15), pages 1261 to 1265, porous inorganic solid bodies, which can be obtained by drying and sintering mixtures of polymer particles and ultrafine metal oxide particles.

The prior art also includes a series of processes which relate to the heating of polymer particles coated with finely divided inorganic particles but in which no porous inorganic solid bodies are formed but instead small hollow inorganic spheres. Examples thereof are to be found in H. Bamnolker et al. in J. Mat. Sci. Lett. 1997, 16, pages 1412 to 1415, N. Kawahashi and E. Matijevic in J. Colloid and Interf. Sci. 1990, 138, pages 534 to 542, N. Kawahashi and E. Matijevic in J. Colloid and Interf. Sci. 1991, 143, pages 103 to 110, N. Kawahashi and E. Matijevic in J. Mater. Chem. 1991, 1(4), pages 577 to 582, F. Caruso et al. in Science 1998, 281, pages 1111 to 1114, F. Caruso et al. in J. Am. Chem. Soc. 1998, 120, pages 8523 to 8524 and also F. Caruso et al. in Adv. Mater. 1999, 11(11), pages 950 to 952. Generally, these manufacturing processes involve the coating of polymer particles having a high glass transition temperature with inorganic solid material. The coated polymer particle are then heated, during which process the polymer is converted to volatile constituents and there remain hollow inorganic spheres having a diameter of a few micro-meters.

It is an object of the invention to provide, in view of the above prior art, a novel process for the preparation of porous inorganic solid bodies, which is universally applicable and does not exhibit the limitations of the sol-gel process.

Accordingly, we have found a process for the preparation of porous inorganic solid bodies from an aqueous dispersion of particles composed of polymer and finely divided inorganic solid matter, which is characterized in that

a) the aqueous dispersion is poured into an open mold or is applied to a surface, after which

b) the aqueous dispersion is dried at a temperature equal to or greater than its minimum film-forming temperature, after which

c) the resulting film of polymer and inorganic solid matter is heated to an elevated temperature and the polymer is converted to volatile constituents.

Aqueous dispersions of particles composed of polymer and finely divided inorganic solid matter (composite particles), are well known. These are fluid systems comprising, as disperse phase distributed throughout an aqueous dispersion medium, particles composed of a polymer clew consisting of a number of entangled polymer chains, the so-called polymer matrix, and finely divided inorganic solid matter. The preparation of such dispersions of composite particles is described, for example, in the applications filed by the applicant at the German Patent and Trade Mark Office under file numbers 1,994,2777.1 and 1,995,0464.4 and in the references cited therein.

The composite particles used according to the invention in the form of an aqueous dispersion can contain, as finely divided inorganic solid matter, any metals, metal compounds, such as metallic oxides and metal salts, but also semimetallic compounds. The finely divided metal powders used can be noble metal colloids, such as palladium, silver, ruthenium, platinum, gold and rhodium, and alloys containing the same. As examples of finely divided metallic oxides there may be mentioned titanium(IV) oxide (for example commercially available as Hombitec® brands sold by Sachtleben Chemie GmbH), zirconium(IV) oxide, tin(II) oxide, tin(IV) oxide (for example commercially available as Nyacol® SN brands sold by Akzonobel), aluminum oxide (for example commercially available as Nyacol® AL brands sold by Akzonobel), barium oxide, magnesium oxide, various iron oxides, such as iron(II) oxide (wuestite), iron(III) oxide (haematite) and iron(II) oxide (magnetite), chromium(III) oxide, antimony(III) oxide, bismuth(III) oxide, zinc oxide (for example commercially available as Sachtotece brands sold by Sachtleben Chemie GmbH), nickel(II) oxide, nickel(III) oxide, cobalt(II) oxide, cobalt(III) oxide, copper(II) oxide, yttrium(III) oxide (for example commercially available as Nyacole® YTTRIA brands sold by Akzonobel), cerium(IV) oxide (for example commercially available as Nyacol® CEO 2 brands sold by Akzonobel) amorphous and/or in various crystal modifications and also their hydroxy oxides, such as hydroxytitanium(IV) oxide, hydroxyzirconium(IV) oxide, hydroxyaluminum oxide (for example commercially available as Disperal® brands sold by Condeachemie GmbH) and hydroxyiron(III) oxide amorphous and/or in various crystal modifications.

The following metal salts, which can be present in the amorphous state and/or in various crystalline states can theoretically form the composite particles to be used in the present invention: sulfides, such as iron(II) sulfide, iron(III) sulfide, iron(II) disulfide (iron pyrites), tin(II) sulfide, tin(IV) sulfide, murcury(II) sulfide, cadmium(II) sulfide, zinc sulfide, copper(II) sulfide, silver sulfide, nickel(II) sulfide, cobalt(II) sulfide, cobalt(III) sulfide, manganese(II) sulfide, chromium(III) sulfide, titanium(II) sulfide, titanium(III) sulfide, titanium(IV) sulfide, zirconium(IV) sulfide, antimony(III) sulfide, bismuth(III) sulfide, hydroxides, such as tin(II) hydroxide, aluminum hydroxide, magnesium hydroxide, calcium hydroxide, barium hydroxide, zinc hydroxide, iron(II) hydroxide, iron(III) hydroxide, sulfates, such as calcium sulfate, strontium sulfate, barium sulfate, lead(IV) sulfate, carbonates, such as lithium carbonate, magnesium carbonate, calcium carbonate, zinc carbonate, zirconium(IV) carbonate, iron(II) carbonate, iron(III) carbonate, orthophosphates, such as lithium orthophosphate, calcium orthophosphate, zinc orthophosphate, magnesium orthophosphate, aluminum orthophosphate, tin(III) orthophosphate, iron(II) orthophosphate, iron(III) orthophosphate, metaphosphates, such as lithium metaphosphate, calcium metaphosphate, aluminum metaphosphate, diphosphates, such as magnesium diphosphate, calcium diphosphate, zinc diphosphate, iron(III) diphosphate, tin(II) diphosphate, ammonium phosphates, such as magnesium ammonium phosphate, zinc ammonium phosphate, hydroxylapatite [Ca₅{(PO₄)₃OH}], orthosilicates, such as lithium orthosilicate, calcium/magnesium orthosilicate, aluminum orthosilicate, iron(II) orthosilicate, iron(III) orthosilicate, magnesium orthosilicate, zinc orthosilicate, zirconium(III) orthosilicate, zirconium(IV) orthosilicate, metasilicates, such as lithium metasilicate, calcium/magnesium metasilicate, calcium metasilicate, magnesium metasilicate, zinc metasilicate, lamellar silicates, such as sodium aluminum silicate and sodium magnesium silicate particularly in spontaneously delaminating form, such as Optigel® SH (trade mark of Sudchemie AG), Saponit® SKS 20 and Hektorit® SKS 21 (trade marks of Hoechst AG) and also Laponite® RD and Laponite® GS (trade marks of Laporte Industries Ltd.), aluminates, such as lithium aluminate, calcium aluminate, zinc aluminate, borates, such as magnesium metaborate, magnesium orthoborate, oxalates, such as calcium oxalate, zirconium(IV) oxalate, magnesium oxalate, zinc oxalate, aluminum oxalate, tatrates, such as calcium tatrate, acetylacetonates, such as aluminum acetylacetonate, iron(III) acetylacetonate, salicylates, such as aluminum salicylate, citrates, such as calcium citrate, iron(II) citrate, zinc citrate, palmitates, such as aluminum palmitate, calcium palmitate, magnesium palmitate, aluminates, such as lithium aluminate, calcium aluminate, zinc aluminate, borates, such as magnesium metaborate, magnesium orthoborate, stearates, such as aluminum stearate, calcium stearate, magnesium stearate, zink stearate, laurates, such as calcium laurate, linoleates, such as calcium linoleate, oleates, such as calcium oleate, iron(II) oleate or zinc oleate. An example of an important semi-metallic compound is silicon dioxide in its amorphous and/or various crystalline states.

Special preference is given to compounds selected from the group comprising silicon dioxide, aluminum oxide, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphosphate, magnesium metaphosphate, calcium diphosphate, magnesium diphosphate, iron(II) oxide, iron(III) oxide, iron(II) oxide, titanium(IV) oxide, hydroxylapatite, zinc oxide and zinc sulfide. Particular preference is given to silicon dioxide, aluminum oxide, hydroxyaluminum oxide, calcium carbonate, magnesium carbonate, calcium orthophosphate, hydroxylapatite and titanium(IV) oxide.

It is advantageous when the finely divided inorganic solids present in the composite particles have a weight-average particle diameter of ≦100 nm. Such finely divided inorganic solids are successfully used in composite particles, when the particles dispersed in an aqueous medium have a weight-average particle diameter of ≧1 nm but ≦90 nm, ≦80 nm, ≦70 nm, ≦60 nm, ≦50 nm, ≦40 nm, ≦30 nm, ≦20 nm or ≦10 nm and all values in between. Determination of the weight-average particle diameters can be carried out, for example, by the method of analytical ultracentrifugation (cf S. E. Harding et al., Analytical Ultracentrifugation in Biochemistry and Polymer Science, Royal Society of Chemistry, Cambridge, Great Britain 1992, Chapter 10, Analysis of Polymer Dispersions with an Eight-Cell-AUC-Multiplexer: High Resolution Particle Size Distribution and Density Gradient Techniques, W. Mächtle, pages 147 to 175).

Frequently the aqueous dispersions of composite particles contain dispersing agents, which keep both the finely divided inorganic solids particles and the monomer droplets and the resulting composite particles well dispersed in the aqueous phase, for example when said dispersions are formed by aqueous free-radical emulsion polymerization, and they thus ensure stability of the resulting aqueous dispersion of composite particles. Suitable dispersing agents are the protective colloids conventionally employed when carrying out aqueous free-radical emulsion polymerizations or emulsifiers.

Suitable protective colloids are for example polyvinyl alcohols, polyalkylene glycols, alkali metal salts of polyacrylic acids and polymethacrylic acids, cellulose, starch and gelatine derivatives or copolymers containing acrylic acid, methacrylic acid, maleic anhydride, 2-acrylamido-2-methylpropanesulfonic acid and/or 2-styrenesulfonic acid and their alkali metal salts but also homopolymers and copolymers containing N-vinylpyrrolidone, N-vinyl-caprolactam, N-vinyl carbazole, 1-vinyl imidazole, 2-vinyl imidazole, 2-vinyl pyridine, 4-vinyl pyridine, acrylamide, methacrylamide, amine group-carrying acrylates, methacrylates, acrylamides and/or methacrylamides. A detailed description of other suitable protective colloids is given in Houben-Weyl, Methoden der organischen Chemie, Vol. XIV/1, Macromolekulare Stoffe, Georg-Thieme-Verlag, Stuttgart, 1961, pages 411 to 420.

Of course, mixtures of emulsifiers and/or protective colloids can be used, if desired. Frequently the dispersing agents used are exclusively emulsifiers whose relative molecular weights are, unlike the protective colloids, usually below 1500. They can be of an anionic, cationic or non-ionic nature. Of course, when use is made of mixtures of surfactants, the constituents have to be compatible with each other, which can be checked if necessary by a few preliminary tests. Generally, anionic emulsifiers are compatible with each other and with non-ionic emulsifiers. The same applies to cationic emulsifiers, whilst anionic and cationic emulsifiers are not usually compatible with each other. An overview of suitable emulsifiers is given in Houben-Weyl, Methoden der organischen Chemie, Vol. XIV/1, Macromolekulare Stoffe, Georg-Thieme-Verlag, Stuttgart, 1961, pages 192 to 208.

Commonly used non-ionic emulsifiers are for example ethoxylated mono-, di- and tri-alkylphenols (degree of ethoxylation: 3 to 50, alkyl group: C₄ to C₁₂) and also ethoxylated fatty alcohols (degree of ethoxylation: 3 to 80; alkyl group: C₈ to C₃₆). Examples thereof are the Lutensol® A brands (C₁₂C₁₄ fatty alcohol ethoxylates, degree of ethoxylation: 3 to 8), Lutensol® AO brands (C₁₃C₁₅ oxoalcohol ethoxylates, degree of ethoxylation: 3 to 30), Lutensol® AT brands (C₁₆C₁₈ fatty alcohol ethoxylates, degree of ethoxylation: 11 to 80), Lutensol® ON brands (C₁₀ oxoalcohol ethoxylates, degree of ethoxylation: 3 to 11) and the Lutensol® TO brands (C₁₃ oxoalcohol ethoxylates, degree of ethoxylation: 3 to 20) sold by BASF AG.

Common anionic emulsifiers are for example alkali metal and ammonium salts of alkyl sulfates (alkyl group: C₈ to C₁₂) , of sulfuric acid half-esters of ethoxylated alkanols (degree of ethoxylation: 4 to 30, alkyl group: C₁₂ to C₁₈) and ethoxylated alkylphenols (degree of ethoxylation: 3 to 50, alkyl group: C₄ to C₁₂), of alkylsulfonic acids (alkyl group: C12 to C18) and of alkylarylsulfonic acids (alkyl group: C₉ to C₁₈)

Compounds of the general formula I

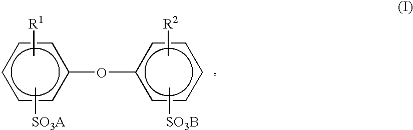

in which R¹ and R² denote hydrogen atoms or C₄-C₂₄ alkyl but are not both hydrogen atoms, and A and B can be alkali metal ions and/or ammonium ions, have been found to be other suitable anionic emulsifiers. In general formula I, R¹ and R² preferably denote linear or branched alkyl groups containing from 6 to 18 carbons, particularly 6, 12 and 16 carbons or —H, but R¹ and R² are not both hydrogen atoms. A and B are preferably sodium, potassium or ammonium, sodium being particularly preferred. Compounds I are particularly advantageous in which A and B are sodium, R¹ is a branched alkyl group containing 12 carbons and R² is a hydrogen atom or R¹. Frequently commercial mixtures are used which contain from 50 to 90 wt % of the monoalkylated product, such as Dowfax® 2A1 (trade mark of Dow Chemical Company). Compounds I are well known, eg from U.S. Pat. No. 4,269,749, and are commercially available.

Suitable cation-active emulsifiers are usually primary, secondary, tertiary or quaternary ammonium salts, alkanolammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts, which salts contain a C₆-C₁₈ alkyl, C₆-C₁₈ aralkyl or a heterocyclic group. By way of example there may be mentioned dodecylammonium acetate or the corresponding hydrochloride, the chlorides or acetates of the various 2-(N,N,N-trimethylanmonium)ethyl paraffinates, N-cetylpyridinium chloride, N-laurylpyridinium sulfate and N-cetyl-N,N,N -tri-methylammonium bromide, N-dodecyl-N,N,N-trimethylammonium bromide, N-octyl-N,N,N-trimethlyammonium bromide, N,N-distearyl-N,N-dimethylammonium chloride and also the Gemini surfactant N,N′-(lauryldimethyl)ethylenediamine dibromide, ethoxylated tallow fatty acid alkyl-N-methylammonium bromide (for example Ethoquad® HT/25 sold by Akzonobel; ca 15 ethylene oxide units) and ethoxylated oleylamine (for example Uniperol® AC sold by BASF AG, ca 12 ethylene oxide units). Numerous other examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

The aqueous dispersions of composite particles contain usually from 0.05 to 20 wt %, frequently from 0.1 to 5 wt % and more frequently from 0.2 to 3 wt % of dispersing agent, in each case based on the total weight of the composite particles.

Basically, the polymer forming a constituent of the composite particles can be synthesized by free-radical polymerization or, if possible, by anionic or cationic polymerization of ethylenically unsaturated monomers. Both free-radical polymerization and ionic polymerization are known to the person skilled in the art as conventional polymerization methods.

Free-radical polymerization can be carried out for example in solution, for example in water or an organic solvent (solvent polymerization), in aqueous dispersion (emulsion polymerization or suspension polymerization) or in substance, ie substantially in the absence of water or organic solvents (mass polymerization).

However, the polymer forming one component of the composite particles is advantageously prepared by aqueous free-radical emulsion polymerization. This has been described in many prior publications and is therefore sufficiently known to the person skilled in the art [cf eg Encyclopedia of Polymer Science and Engineering, Vol. 8, pages 659 to 677, John Wiley & Sons, Inc., 1987; D. C. Blackley, Emulsion Polymerization, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerization, pages 1 to 287, Academic Press, 1982; F. Hoelscher, Dispersionen synthetischer Hochpolymerer, pages 1 to 160, Springer-Verlag, Berlin, 1969 and the patent specification DE-A 4,003,422]. It is usually carried out by dispersing the ethylenically unsaturated monomers, frequently together with dispersing agents, in an aqueous medium and effecting polymerization thereof using at least one free-radical polymerization initiator. The synthesis of composite particles differs from this method often only in that the emulsion polymerization is carried out in the presence of a finely divided inorganic solid material.

The polymer is composed of polymerized units of ethylenically unsaturated monomers. The following may be used as monomers for example: ethylene, vinylaromatic monomers, such as styrene, α-methylstyrene, o-chlorostyrene or vinyl toluenes, esters of vinyl alcohol and C₁-C₁₈ monocarboxylic acids, such as vinyl acetate, vinyl propionate, vinyl n-butyrate, vinyl laurate and vinyl stearate, esters of α,β-monoethylenically unsaturated mono- and dicarboxylic acids containing preferably from 3 to 6 carbons, such as, in particular, acrylic acid, methacrylic acid, maleic acid, fumaric acid and itaconic acid, with alkanols containing generally from 1 to 12, preferably from 1 to 8 and more preferably from 1 to 4 carbons, such as, in particular, methyl, ethyl, n-butyl, isobutyl, pentyl, hexyl, heptyl, octyl, nonyl, decyl and ethyl-hexyl (meth)acrylates, dimethyl or di-n-butyl fumarates and maleates, nitriles of α,β-monoethylenically unsaturated hydrocarbons, such as acrylonitrile, methacrylonitrile, fumarodinitrile, maleindinitril and also C₄-C₈ conjugated dienes, such as 1,3-buta-diene and isoprene. The said monomers usually form the main monomers, which together make up more than 80 wt % and preferably more than 90 wt %, based on the polymer. As a general rule, these monomers exhibit only medium to poor solubility in water under standard conditions [20° C., 1 bar (absolute)].

Monomers showing improved water solubility under the aforementioned conditions are those containing either at least one acid group and/or its corresponding anion or at least one amino, amido, ureido or N-heterocyclic group and/or its ammonium derivatives protonated or alkylated on the nitrogen atom. As examples thereof there may be mentioned α,β-monoethylenically unsaturated mono- and di-carboxylic acids and their amides, such as acrylic acid, methacrylic acid, maleic acid, fumaric acid, itaconic acid, acrylamide and methacrylamide, further vinylsulfonic acid, 2-acrylamido-2-methylpropanesulfonic acid, styrenesulfonic acid and water-soluble salts thereof and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide and 2-(1-imidazolinon-2-yl)ethyl methacrylate. Normally the aforementioned monomers are incorporated as polymerized units only as modifying monomers, in amounts, based on the polymer, of less than 10 wt % and preferably less than 5 wt %.

Monomers which usually increase the structural strength of the filmed polymer matrix normally have at least one epoxy, hydroxyl, N-methylol or carbonyl group or at least two non-conjugated ethylenically unsaturated double bonds. Examples thereof are monomers having two vinyl groups, monomers having two vinylidene groups and monomers having two alkenyl groups. Particularly advantageous here are the diesters of dihydroxylic alcohols with α,β-monoethylenically unsaturated monocarboxylic acids, of which acrylic acid and methacrylic acid are particularly preferred. Examples of such monomers having two non-conjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates and ethylene glycol dimethacrylate, 1,2-propylene glycol dimethacrylate, 1,3-propylene glycol dimethacrylate, 1,3-butylene glycol dimethacrylate, 1,4-butylene glycol dimethacrylate and also divinyl benzene, vinyl methacrylate, vinyl acrylate, allyl methacrylate, allyl acrylate, diallyl maleate, diallyl fumarate, methylene bisacrylamide, cyclopentadienyl acrylate, triallyl cyanurate and triallylisocyanurate. Particularly significant in this context are, in addition, the C₁-C₈ hydroxyalkyl (meth)acrylates such as n-hydroxyethyl, n-hydroxypropyl or n-hydroxybutyl (meth)acrylates and also compounds such as diacetone acrylamide and acetylacetoxyethyl (meth)acrylate. The aforementioned monomers are frequently present as polymerized units in the polymer in amounts of up to 10 wt % but preferably less than 5 wt %.

It is particularly advantageous when the polymer is composed, to at extent of at least 50 wt %, preferably at least 90 wt % and more preferably at least 95 wt%, of at least one monomer selected from the following group, in the form of polymerized units: esters of vinyl alcohol and monocarboxylic acids having from 1 to 10 carbons, esters of acrylic acid, methacrylic acid, maleic acid and fumaric acid with an alcohol having from 1 to 10 carbons, vinylaromatic monomer and/or α,β-unsaturated C₃ or C₄ carboxynitrile or α,β-unsaturated C₄-C₆ carboxydinitrile.

The composite particles used in the invention usually possess particle diameters of ≦5000 nm, frequently ≦1500 nm and often ≦400 nm. It is advantageous when the composite particles exhibit a particle diameter of ≧50 nm and ≦800 nm or ≧100 nm and ≦600 nm. Determination of the particle diameter is usually carried out by taking transmission electron microscopic readings (cf eg L. Reimer, Transmission Electron Microscopy, Springer-Verlag, Berlin, Heidelberg, 1989; D.C. Joy, The Basic Principles of EELS in Principles of Analytical Electron Microscopy, edited by D.C. Joy, A. D. Romig, Jr. and J. I. Goldstein, Plenum press, New York, 1986; L. C. Sawyer and D. T. Grupp, Polymer Microscopy, Chapman & Hall, London, 1987).

In the composite particles, the ratio, by weight, of polymer to finely divided inorganic solid matter is usually from 90:10 to 20:80, frequently from 85:15 to 30:70 and often from 80:20 to 40:60.

The composite particles which can be used in the process of the invention can exhibit different structures. The composite particles usually contain a plurality of the inorganic solid particles. The inorganic solid particles can be completely surrounded by the polymer. Another possibility is that some of the inorganic solid particles are surrounded by the polymer, while others are disposed on the surface of the polymer. Of course, another possibility is that a major portion of the inorganic solid particles adheres to the surface of the polymer. Preference is given to the use of composite particles whose inorganic solid particles are disposed on the surface of the polymer to an extent of ≧50 wt %, ≧60 wt %, ≧70 wt %, ≧80 wt % or ≧90 wt % and all values in between, in each case based on the total weight of inorganic solid particles present in the composite particles.

The concentration of composite particles in the aqueous dispersion of composite particles used in accordance with the invention is usually between ≧1 and ≦80 wt %, frequently between ≧5 and ≦70 wt % and often between ≧10 and ≦60 wt %.

To prepare the porous inorganic solid bodies, the dispersion of composite particles is first of all poured into an open mold or applied to a surface.

By an open mold we mean, in this context, a mold comprising a baseplate attached to side walls which are closed all round. The baseplate can be plane or have a surface structure and be of any desired shape and size. However it is important that the plate be provided with closed side walls. Since the open mold is frequently the negative mold of the porous inorganic solid body to be produced by the process of the invention, it is usually shaped so as to correspond to the desired shape of the porous inorganic solid body. The mold is usually made of a material which is inert to the inorganic solid material present in the composite particles and thus allows for easy removal of the porous inorganic solid body at the end of the process. Examples of shaping materials are high-grade steels, noble metals and high-melting ceramics. Another basic possibility is to take the film obtained after drying out of the mold and to shape this by cutting it as desired with a sharp-edged object, such as a knife, scissors, blanking dies etc.. In this case the form can consist of polyethylene, polypropylene, polystyrene, Teflon, silicone gum, glass or various high-grade steels for example.

By surface we mean a portion or all of the surface of any three-dimensional body. Examples of such three-dimensional bodies are rings of any size, spheres of any size, cylinders of any size and having various width-to-length proportions or wooden cylinders of any size and having various width-to-length proportions but also honeycomb and network structures of various sizes and shapes. Particularly suitable materials for said three-dimensional bodies are noble metals and metal oxides and semimetal oxides, such as silicon dioxide, aluminum oxide, cerium(IV) oxide, tin(IV) oxide, zirconium(IV) oxide and titanium(IV) oxide.

It is essential for the success of the process that the aqueous dispersion of composite particles in the open mold or on the surface is dried at a temperature which is the same as or greater than the minimum film-forming temperature of the dispersion of composite particles. Drying can take place under a blanket of inert gas or atmospheric air. It is particularly advantageous when the relative humidity of the inertgas or air over the aqueous dispersion of composite particles during the drying operation is ≦50%. The drying temperature is usually set to ≧1° C., ≧5° C., ≧10° C., ≧15° C. or still higher values above the minimum film-forming temperature of the dispersion of composite particles. The period of time that is required for the drying process is governed, inter alia, by the temperature used, the relative humidity of the inert gas or air and the thickness of the film. It can be from a few minutes to several days. The drying period is routinely frequently 24 hours or 36 hours or 48 hours or can be precisely determined by the person skilled in the art in simple preliminary tests.

In particular, the aqueous dispersions of composite particles used for the process of the invention are such as have a minimum film-forming temperature of <100° C., preferably ≦50° C. and more preferably ≦30° C. Since the minimum film-forming temperature is no longer measurable below 0° C., the lower limit of the minimum film-forming temperature can only be given in terms of the glass transition temperature of the polymer. The glass transition temperatures should not fall below −60° C. and preferably not below −30° C. Determination of the minimum film-forming temperature is carried out as specified in DIN 53,787 or ISO 2115 and determination of the glass transition temperature as specified in DIN 53,765 (Differential Scanning Calorimetry, 20 K/min, mid-point reading).

The drying process can theoretically take place under ambient pressure (lbar absolute), under reduced pressure (<1 bar absolute) and under elevated pressure (>1 bar absolute) over a pressure range of from 10 mbar to 100 bar (absolute). However, drying is frequently carried out under ambient pressure. If the minimum film-forming temperature of the polymer is ≧100° C., it is advisable to carry out the drying process under elevated pressure, for example at 1.5 bar, 2 bar, 3 bar (absolute) or even higher pressures.

The thickness of the film comprising polymer and inorganic solid matter can be up to 10 mm. However, usual film thicknesses are ≦5 mm, ≦4 mm, ≦3 mm, ≦2 mm, ≦1 mm, ≦0.5 mm, ≦0.1 mm and ≧0.01 mm and also all values in between. It may be advisable, particularly when the layer thickness is large, to carry out synthesis in a stepwise manner, ie a thin layer of the aqueous dispersion of composite particles is first of all formed in the mold or applied to said surface and dried as stated above. This process is then repeated a number of times until the desired thickness of the film is achieved.

Following drying, the film formed is brought to an elevated temperature and the polymer caused to react to produce volatile constituents. Depending on the nature of the finely divided inorganic solid matter and the material of the mold or three-dimensional body providing said surface, heating is effected up to temperatures of 1000° C. Heating to still higher temperatures is conceivable but is practised only in exceptional cases. Usually the film is heated to a temperature of ≧350° C. but ≦700° C. The temperature is usually set to that at which the finely divided inorganic solid matter begins to sinter. This temperature is known to the person skilled in the art or can be determined in simple preliminary tests.

It is advantageous when the film is heated at a rate of ≧0.1° but ≦50° C., preferably ≧2° C. but ≦20° C. Theoretically however, other heating rates are possible. During heat-up, different heating rates can be used, for example in ramp mode, if desired.

When the desired elevated temperature has been reached, the film is kept at this temperature until the organic polymer has been completely converted to volatile constituents and the remaining finely divided inorganic solid matter has formed a porous inorganic solid body. The time required can be from a few minutes to several days. Usually the said period is from 0.5 to 20 hours, preferably from 2 to 8 hours. Heating and the transformation of the polymer to volatile constituents at elevated temperature can take place, theoretically, under ambient pressure (1 bar absolute), under reduced pressure (<1 bar absolute) or under elevated pressure (>1 bar absolute) over a pressure range of from 10 mbar to 100 bar (absolute). However, heating is frequently carried out under ambient pressure.

Heating to and at said elevated temperature can take place under a blanket of inert gas or alternatively under an oxygen-containing atmosphere. The inert gases used are for example helium, argon, nitrogen or carbon dioxide. These inert gases can be mixed with oxygen in any ratio. Preferably, air is frequently used as oxygen-containing gas. Another possibility, of course, is to use oxygen that is free from inert gas, optionally in vacuo. It is frequently advantageous when heating to and at the elevated temperature is first of all carried out under an atmosphere of inert gas and the inert gas is then gradually oxygen-enriched, as can take place, for example, by mixing in air or oxygen. Of course, it is possible to start with an inert gas, which is then continuously replaced by oxygen.

The porous inorganic solid bodies obtained after cooling are distinguished by a high degree of porosity. However, it is important to observe the fact that slight shrinkage can occur during heat treatment of the film of polymer and inorganic solid matter, so that the porous inorganic solid body is smaller in size than the original film. But this does not usually alter the proportions (ie the ratio of length to width to height). Generally, the degree of shrinkage is however ≦20%, ≦15% or ≦10%, based, in each case, on the original size of the film.

The porous inorganic solid bodies produced by the process of the invention can be used in diverse manner, particularly as catalyst supports, as membranes for the separation of multiphase mixtures of substances, particularly for the separation of solids from liquids in chemical manufacturing processes, in waste-water treatment and in biotechnological processes, as adsorbent material, particularly for the separation of substances from liquid mixtures of substances, for example in the foodstuff industry for the separation of proteins from beer, as thermally-insulating and/or sound-insulating materials and also as light construction materials for the building, electronics and microelectronics industries and also as supporting or partitioning materials for use in liquid chromatographic analysis.

### EXAMPLES

In the following examples, the finely divided inorganic solid matter used was silicon dioxide or tin(IV) oxide. By way of exemple, there were used the commercially available sols Nyacol® 2040 [silicon dioxide (20 nm)] and Nyacol® SN 15 [tin(IV) oxide (from 10 to 15 nm) sold by Akzo Nobel. The values in round brackets relate to the diameters of the respective inorganic solid particles as stated by the manufacturers.

Example 1

1.1 Preparation of an aqueous dispersion of composite particles

In a four-knecked flask having a capacity of 500 mL, 60 g of deionized, oxygen-free water and 1.5 g of 1 M hydrochloric acid were used as initial batch under a blanket of nitrogen at 20° C. under a pressure of 1 bar (absolute), and 20 g of Nyacol® 2040 were added with stirring (250 rpm). The aqueous phase was then adjusted to pH 2.5 with 1.62 g of 1 M hydrochloric acid and it was made up to 100 g with deionized, oxygen-free water, which had been set to pH 2.5 with 1M hydrochloric acid. The reaction mixture was then heated to a reaction temperature of 85° C. The pH of this aqueous phase, measured at ambient temperature, was 2.5.

An aqueous emulsion comprising 10 g of methyl methacrylate, 10 g of 2-ethylhexyl acrylate, 80 g of deionized, oxygen-free water, 1 g of a 20 wt % strength aqueous solution of the non-ionic emulsifier LUTENSOL® AT18 and 0.05 g of 4-vinyl pyridine (feed stream 1) was prepared in a parallel setup. An initiator solution was prepared from 0.45 g of sodium peroxodisulfate and 45 g of deionized, oxygen-free water (feed stream 2).

5 g of feed stream 2 were added to the stirred reaction medium at the reaction temperature. After a lapse of 5 minutes, there were metered to the stirred reaction medium, at the reaction temperature, feed stream 1 over a period of 2 hours and, commencing concurrently therewith, the remainder of feed stream 2 over a period of 2.5 hours. The reaction mixture was then stirred for a further hour at the reaction temperature and then cooled to room temperature.

The resulting dispersion of composite particles had a solids content of 11.1 wt %, based on the total weight of the aqueous dispersion of composite particles. The presence of raspberry-shaped composite particles having a diameter of approximately 220 nm was detected by means of transmission electron microscopic investigation. Free silicon dioxide particles were virtually undetectable.

1.2 Preparation of the porous inorganic solid body

8 g of the aqueous dispersion obtained as described under heading 1.1 were poured into a polyethylene dish having a diameter of approximately 5 cm. The thickness of the moist layer was ca 4 mm. The aqueous dispersion of composite particles was dried over a period of 24 hours at 20° C. and a relative humidity of 50%. There was obtained a coherent film. The minimum film-forming temperature was generally determined according to ISO 2115 using a temperature gradient oven Thermostair® sold by Coesfeld Materialtest GmbH, Dortmund. In the present example it was 7° C.

A sample weighing ca 10 mg was cut out of this film and examined by thermogravimetry using an apparatus comprising a Mettler® TA 4000 System including a M3 balance sold by Mettler, Giessen, Germany. The sample was heated at a rate of 10° C./min under a blanket of nitrogen from 20° C. to 550° C. and then under atmospheric air to 900° C. The polymer decomposed from a temperature of ca 390° C. upwards, as a result of which the sample lost 68.5 wt % of its original weight. A second loss in weight of 1.4 wt %, likewise based on the original weight of the specimen, occurred from ca 555° C. upwards after air had been introduced into the sample chamber. The total weight loss amounting to 69.9 wt % is a good approximation of the theoretical copolymer content of 70 wt % in the composite particle. Following cooling, a white inorganic solid body was obtained.

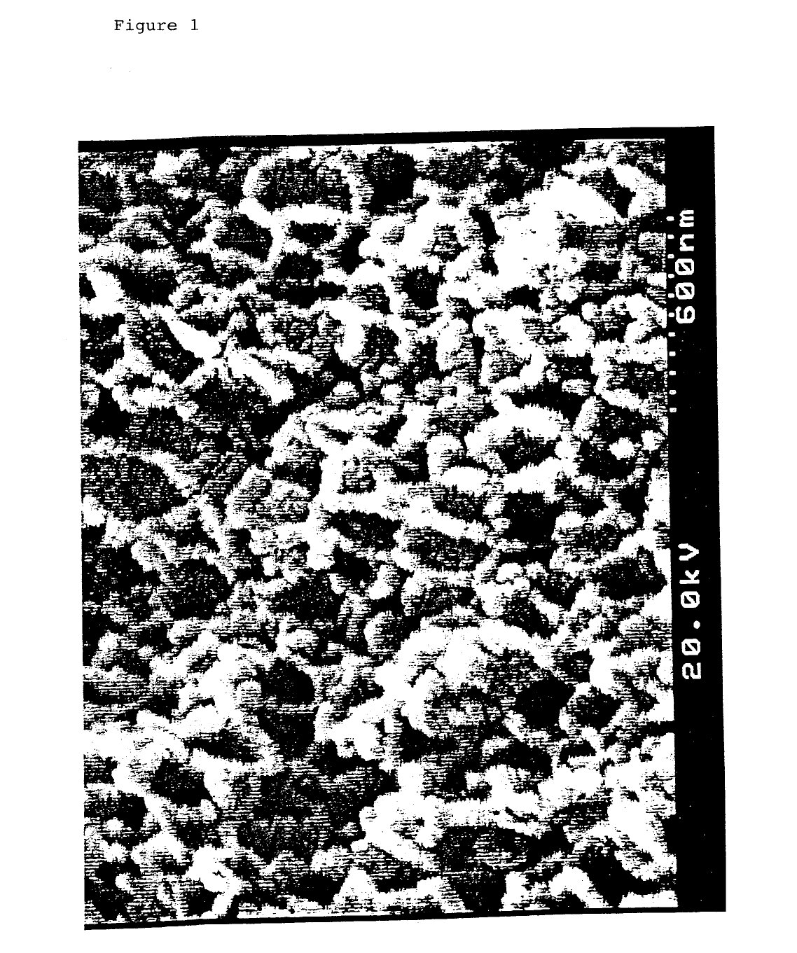

The resulting solid body was broken and the fracture facet examined with a scanning electron microscope. FIG. 1 shows a three-dimensional network of silicon dioxide particles and cavities. The diameters of the cavities are approximately from 100 to 300 nm.

In another experiment, a rectangular piece having a length of 3 cm and a width of 2 cm was cut out from the film obtained above. In a temperature-controlled oven (a Nabatherm® C8 sold by Nabatherm, Bremen, as used in all examples) this piece of film was heated from 20° C. to 600° C. over a period of 2 hours in atmospheric air and kept at this temperature for one hour. After cooling to ambient temperature, there was obtained a rectangular white porous body, whose edge lengths were ca 2.7 cm and 1.8 cm.

A drop of deionized water was pipetted onto the resulting solid material. Within seconds the water penetrated into the porous solid matter and increased the transparency of the white solid matter at the point of penetration to a state of milky opalescence.

Example 2

2.1 Preparation of an aqueous dispersion of composite particles

In a four-knecked flask having a capacity of 500 mL, 60 g of deionized, oxygen-free water and 1.5 g of lM hydrochloric acid were used as initial batch under a blanket of nitrogen at 20° C. under a pressure of 1 bar (absolute), and 20 g of Nyacol® 2040 were added with stirring (250 rpm). The aqueous phase was then adjusted to pH 2.5 with 1.62 g of 1 M hydrochloric acid and it was made up to 100 g with water, which had been set to pH 2.5 with 1 M hydrochloric acid. The reaction mixture was then heated to a reaction temperature of 75° C. The pH of this aqueous phase, measured at ambient temperature, was 2.5.

In a parallel setup, there was prepared an aqueous emulsion comprising 10 g of styrene, 10 g of n-butyl acrylate, 80 g of deionized, oxygen-free water, 1 g of a 20 wt % strength aqueous solution of the non-ionic emulsifier LUTENSOL® AT18 and 0.05 g of 4-vinyl pyridine (feed stream 1). An initiator solution was prepared from 0.23 g of ammonium peroxodisulfate and 45 g of deionized, oxygen-free water (feed stream 2).

5 g of feed stream 2 were added to the stirred reaction medium at the reaction temperature. After a lapse of 5 minutes, there were metered to the stirred reaction medium, at the reaction temperature, feed stream 1 over a period of 2 hours and, commencing concurrently therewith, the remainder of feed stream 2 over a period of 2.5 hours. The reaction mixture was then stirred for a further hour at the reaction temperature and then cooled to room temperature.

The resulting dispersion of composite particles had a solids content of 11.1 wt %, based on the total weight of the aqueous dispersion of composite particles. The presence of raspberry-shaped composite particles having a diameter of approximately 220 nm was detected by means of transmission electron microscopic investigation. Free silicon dioxide particles were virtually undetectable.

2.2 Preparation of the porous inorganic solid body

8 g of the aqueous dispersion obtained as described under heading 2.1 were poured into a polyethylene dish having a diameter of approximately 5 cm. The thickness of the moist layer was ca 4 mm. The aqueous dispersion of composite particles was dried over a period of 24 hours at 20° C. and a relative humidity of 50%. There was obtained a coherent film. The minimum film-forming temperature was found to be 17° C.

A rectangular piece having a length of 3 cm and a width of 2 cm was cut out from the resulting film. In a temperature-controlled oven this piece of film was heated from 20° C. to 600° C. over a period of 2 hours in atmospheric air and kept at this temperature for one hour. After cooling to ambient temperature, there was obtained a rectangular white porous body, whose edge lengths were ca 2.7 cm and 1.8 cm.

Example 3

3.1 Preparation of an aqueous dispersion of composite particles

In a four-knecked flask having a capacity of 500 mL and equipped with a reflux condenser, thermometer, mechanical stirrer and metering means, there were placed 60 g of deionized, oxygen-free water and 1.5 g of 1 M hydrochloric acid under a blanket of nitrogen at 20° C. under a pressure of 1 bar (absolute), and 20 g of Nyacol® 2040 were added with stirring (250 rpm). The aqueous phase was then adjusted to pH 2.5 with 1.62 g of 1 M hydrochloric acid and it was made up to 100 g with water, which had been adjusted to pH 2.5 with 1 M hydrochloric acid. The reaction mixture was then heated to a reaction temperature of 75° C. The pH of this aqueous phase, measured at ambient temperature, was 2.5.

In a parallel setup, there was prepared an aqueous emulsion, comprising 10 g of styrene and 10 g of n-butyl acrylate, 80 g of deionized, oxygen-free water and 0.2 g of N-cetyl-N,N,N -trimethylammonium bromide (feed stream 1). An initiator solution was prepared from 0.45 g of ammonium peroxodisulfate and 44.55 g of deionized, oxygen-free water (feed stream 2).

5 g of feed stream 2 were added to the stirred reaction medium at the reaction temperature. After a lapse of 5 minutes, there were metered to the stirred reaction medium, at the reaction temperature, feed stream 1 over a period of 2 hours and, commencing concurrently therewith, the remainder of feed stream 2 over a period of 2.5 hours. The reaction mixture was then stirred for a further hour at the reaction temperature and then cooled to room temperature.

The resulting dispersion of composite particles had a solids content of 11.3 wt %, based on the total weight of the aaueous dispersion of composite particles. Raspberry-shaped composite particles having a diameter of approximately from 180 to 300 nm were detected by means of transmission electron microscopic investigation. Free silicon dioxide particles were virtually undetectable.

3.2 Preparation of the porous inorganic solid body

8 g of the aqueous dispersion obtained as described under heading 3.1 were poured into a polyethylene dish having a diameter of approximately 5 cm. The thickness of the moist layer was ca 4 mm. The aqueous dispersion of composite particles was dried over a period of 24 hours at 20° C. and a relative humidity of 50%. There was obtained a coherent film. The minimum film-forming temperature was found to be 15° C.

A piece weighing ca 10 mg was cut out from this film and examined by thermogravimetry by means of an apparatus, comprising a Mettler® TA 4000 System including a M3 balance. The sample was heated at a rate of 10° C./min under a blanket of nitrogen from 20° C. to 550° C. and then under atmospheric air to 900° C. The polymer decomposed from a temperature of ca 410° C. upwards, as a result of which the sample lost 67.7 wt % of its original weight. A second loss in weight of 2.5 wt %, likewise based on the original weight of the specimen, occurred from ca 560° C. upwards after air had been introduced into the sample chamber. The total weight loss amounting to 70.2 wt % is a good approximation of the theoretical copolymer content of 70 wt % in the composite particle. Following cooling, a white inorganic solid body was obtained.

In another experiment, a rectangular piece having a length of 3 cm and a width of 2 cm was cut out from the film obtained above. In a temperature-controlled oven this piece of film was heated from 20° C. to 600° C. over a period of 2 hours in atmospheric air and kept at this temperature for one hour. After cooling to ambient temperature, there was obtained a rectangular white porous body, whose edge lengths were ca 2.7 cm and 1.8 cm.

Example 4

4.1 Preparation of an aqueous dispersion of composite particles

In a four-knecked flask having a capacity of 500 mL and equipped with a reflux condenser, thermometer, mechanical stirrer and metering means there were used as initial batch 46.7 g of deionized, oxygen-free water and ca 0.02 g of 1M caustic soda solution under a blanket of nitrogen at 20° C. under a pressure of 1 bar (absolute) and 53.3 g of Nyacol® SN 15 (having a tin(IV) oxide solids content of 15 wt %) were added with stirring (250 rpm). The reaction mixture was then heated to a reaction temperature of 85° C. The pH of this aqueous phase, measured at ambient temperature, was 10.

In a parallel setup, there was prepared an aqueous emulsion comprising 10 g of styrene and 10 g of n-butyl acrylate, 1.5 g of 1M hydrochloric acid, 78.5 g of deionized, oxygen-free water and 0.4 of N-cetyl-N,N,N-trimethylammonium bromide (feed stream 1). An initiator solution was prepared from 0.45 g of sodium peroxodisulfate and 45 g of deionized, oxygen-free water (feed stream 2).

5 g of feed stream 2 were added to the stirred reaction medium at the reaction temperature. After a lapse of 5 minutes, there were metered to the stirred reaction medium, at the reaction temperature, feed stream 1 over a period of 2 hours and, commencing concurrently therewith, the remainder of feed stream 2 over a period of 2.5 hours. The reaction mixture was then stirred for a further hour at the reaction temperature and then cooled to room temperature.

The resultant dispersion of composite particles had a solids content of 11.5 wt %, based on the total weight of the aqueous dispersion of composite particles. Transmission electron microscopic measurements confirmed the presence of raspberry-shaped composite particles having a diameter of approximately 130 nm. Free tin(IV) oxide particles were virtually undetectable.

4.2 Preparation of the porous inorganic solid body

8 g of the aqueous dispersion obtained as described under heading 4.1 were poured into a polyethylene dish having a diameter of approximately 5 cm. The thickness of the moist layer was ca 4 mm. The aqueous dispersion of composite particles was dried over a period of 24 hours at 20° C. and a relative humidity of 50%. There was obtained a coherent film. The minimum film-forming temperature was found to be 15° C.

A rectangular piece having a length of 3 cm and a width of 2 cm was cut out from the resulting film. In a temperature-controlled oven this piece of film was heated from 20° C. to 600° C. over a period of 2 hours in atmospheric air and kept at this temperature for one hour. After cooling to ambient temperature, there was obtained a rectangular white porous body, whose edge lengths were ca 2.7 cm and 1.8 cm.

Example 5

5.1 Preparation of an aqueous dispersion of composite particles

In a four-knecked flask having a capacity of 500 mL and equipped with a reflux condenser, thermometer, mechanical stirrer and metering means, there were placed 66 g of deionized, oxygen-free water and 1.5 g of lM hydrochloric acid under a blanket of nitrogen at 20° C. under a pressure of 1 bar (absolute), and 13.3 g of Nyacol® 2040 were added with stirring (250 rpm). The aqueous phase was then adjusted to pH 2.5 with 1.5 g of 1M hydrochloric acid and it was made up to 100 g with water, which had been adjusted to pH 2.5 with lM hydrochloric acid. The reaction mixture was then heated to a reaction temperature of 85° C. The pH of this aqueous phase, measured at ambient temperature, was 2.5.

In a parallel setup, there was prepared an aqueous emulsion, comprising 10 g of styrene and 10 g of n-butyl acrylate, 80 g of deionized, oxygen-free water and 0.2 g of N-cetyl-N,N,N -trimethylammonium bromide (feed stream 1). An initiator solution was prepared from 0.45 g of sodium peroxodisulfate and 44.55 g of deionized, oxygen-free water (feed stream 2).

5 g of feed stream 2 were added to the stirred reaction medium at the reaction temperature. After a lapse of 5 minutes, there were metered to the stirred reaction medium, at the reaction temperature, feed stream 1 over a period of 2 hours and, commencing concurrently therewith, the remainder of feed stream 2 over a period of 2.5 hours. The reaction mixture was then stirred for a further hour at the reaction temperature and then cooled to room temperature.

The resulting dispersion of composite particles had a solids content of 11.5 wt %, based on the total weight of the aqueous dispersion of composite particles. Raspberry-shaped composite particles having a diameter of approximately from 250 to 850 nm were detected by means of transmission electron microscopic investigation. Free silicon dioxide particles were virtually undetectable.

5.2 Preparation of the porous inorganic solid body

8 g of the aqueous dispersion obtained as described under heading 5.1 were poured into a polyethylene dish having a diameter of approximately 5 cm. The thickness of the moist layer was ca 4 mm. The aqueous dispersion of composite particles was dried over a period of 24 hours at 20° C. and a relative humidity of 50%. There was obtained a coherent film. The minimum film-forming temperature was found to be 6° C.

A rectangular piece having a length of 3 cm and a width of 2 cm was cut out from the film obtained above. In a temperature-controlled oven this piece of film was heated from 20° C. to 600° C. over a period of 2 hours in atmospheric air and kept at this temperature for one hour. After cooling to ambient temperature, there was obtained a rectangular white porous body, whose edge lengths were ca 2.7 cm and 1.8 cm.

1. A process for the preparation of porous inorganic solid bodies from an aqueous dispersion of particles composed of polymer and finely divided inorganic solid matter, wherein
a) the aqueous dispersion is poured into an open mold or is applied to a surface, after which
b) the aqueous dispersion is dried at a temperature equal to or greater than its minimum film-forming temperature, after which
c) the resulting film of polymer and inorganic solid matter is heated to an elevated temperature and the polymer is converted to volatile constituents.

2. A process as defined in claim 1, wherein the finely divided inorganic solid matter is selected from the group comprising silicon dioxide, aluminum oxide, tin(IV) oxide, yttrium(III) oxide, cerium(IV) oxide, hydroxyaluminum oxide, calcium carbonate, magnesium carbonate, calcium orthophosphate, magnesium orthophosphate, calcium metaphospate, magnesium metaphosphate, calcium diphosphate, magnesium diphosphate, iron(II) oxide, iron(III) oxide, ironII oxide, titanium(IV) oxide, hydroxylapatite, zinc oxide and zinc sulfide.

3. A process as defined in any of claims 1 and 2, wherein the weight-average diameter of the finely divided inorganic solid matter is ≦100 nm.

4. A process as defined in any of claims 1 to 3, wherein the polymer is composed, to an extent of at least 50 wt %, of at least one monomer of the following group, in the form of polymerized units,: esters of vinyl alcohol and monocarboxylic acids having from 1 to 10 carbon atoms, esters of acrylic acid, methacrylic acid, maleic acid or fumaric acid with an alcohol, vinylaromatic monomers having from 1 to 10 carbon atoms and/or a α,β-unsaturated C₃ or C₄ carboxynitrile or a α,β-unsaturated C₄-C₆ carboxydinitrile.

5. A process as defined in any of claims 1 to 4, wherein the diameter of the particles composed of polymer and finely divided inorganic solid matter is ≧50 and ≦1500 nm, as determined by transmission electron microscopic investigation.

6. A process as defined in any of claims 1 to 5, wherein the minimum film-forming temperature of the aqueous dispersion is <100° C.

7. A process as defined in any of claims 1 to 6, wherein the minimum film-forming temperature of the aqueous dispersion is ≧60° C. and ≦30° C.

8. A process as defined in any of claims 1 to 7, wherein the film is heated to a temperature of ≦1000° C.

9. A process as defined in any of claims 1 to 8, wherein the film is heated to a temperature of ≧350° C. and ≦700° C.

10. A process as defined in any of claims 1 to 9, wherein the film is heated at a rate of ≧0.1° C./min and ≦50° C./min.

11. A process as defined in any of claims 1 to 10, wherein the film is heated in an inert gas atmosphere.

12. A process as defined in any of claims 1 to 10, wherein the film is heated in an oxygen-containing atmosphere.

13. A process as defined in claim 12, wherein the oxygen-containing atmosphere is air.

14. A process as defined in claim 12, wherein the oxygen-containing atmosphere is oxygen.

15. A porous inorganic solid body whenever produced by a process as defined in any of claims 1 to 14.

16. A method of using a porous inorganic solid body as defined in claim 15 as a catalyst support.

17. A method of using a porous inorganic solid body as defined in claim 15 as a membrane.

18. A method of using a porous inorganic solid body as defined in claim 15 as an adsorbent.

19. A method of using a porous inorganic solid body as defined in claim 15 as heat-insulating material.

20. A method of using a porous inorganic solid body as defined in claim 15 as sound-proofing material.

21. A method of using a porous inorganic solid body as defined in claim 15 as light-weight building material.

22. A method of using a porous inorganic solid body as defined in claim 15 as a partitioning support for use in chromatography.
